(19) United States
(12) Patent Application Publication
(10) Pub. No.: US 2012/0106877 A1
(43) Pub. Date: May 3, 2012

(54) FLEXIBLE PACKAGING MATERIAL AND A PACKAGE FORMED THEREWITH

(76) Inventor: Luen-Sing TANG, Tsuen Wan (HK)

(21) Appl. No.: 12/915,281

(22) Filed: Oct. 29, 2010

(51) Int. Cl. B65D 30/02; B65D 33/24; B65D 33/02; B32B 3/04; B31B 1/64; B31B 31/00; B31B 1/14; B32B 3/00; B65D 30/16; B31B 1/26

(52) U.S. Cl. 383/104; 383/98; 383/120; 383/125; 383/119; 493/193; 493/214; 493/243; 493/201; 428/192; 428/121

(57) ABSTRACT

The present disclosure relates to a laminated sheet of flexible packaging material, which includes a first layer formed out of unconnected sheets having substantially abutting adjacent edges, a second layer laminated to the first layer and formed out of a continuously intact sheet where overlapping the adjacent substantially abutting edges of the sheets of the first layer, wherein the adjacent substantially abutting edges of the sheets of the first layer define a line of weakness of the laminated sheet to encourage folding of the laminated sheet along the line of weakness.

### FIELD OF THE INVENTION

The present invention relates to flexible packaging material, such as laminated packaging material, and to a method and apparatus for the production of laminated packaging material. The present invention also relates to a package formed, at least partially, from a laminated packaging material, and to a method and apparatus for the production of a package at least partially formed of laminated packaging material. However, it is to be appreciated that the present invention may have broader application.

### BACKGROUND OF THE INVENTION

It is desirable to be able to mark products, such as, food, in a package formed out of a flexible packaging material that can be formed into a desired shape and configuration and that includes a degree of structural integrity that enables the package to maintain the desired shape and configuration.

Existing packages formed out of a sheet of flexible packaging material can come in a variety of forms. Such forms can include a package formed out of a tube of flexible packaging material that can be sealed at one end to define an interior of the package that can then be filled with contents. After filling with contents, the other end of the package can be sealed to retain the contents within the package during storage and transportation. A package formed in such a way will generally take the form of a flexible bag having little or not structural integrity. During storage and transportation gaps may be formed between adjacent bags resulting in a portion of the volume containing a plurality of the packages being wasted. In other words, such packages do not represent the most efficient use of space for storing and transporting a plurality of such packages.

Furthermore, existing packages formed out of flexible packaging material such as those described above, when presented to consumers in a retail environment, such as on a shelf in a store do not present a neat and tidy appearance to the consumer. Furthermore, any labelling or marketing material printed or otherwise represented on an outside surface of the package will not be represented to the consumer in a neat and clearly legible form. Existing packages formed out of a flexible packaging material may require external support in order to orient the package on a shelf such that product information and marketing material required by a consumer to identify the product, the manufacturer of the product and any other information that the manufacturer wishes to convey to the consumer can be perceived by the consumer without requiring the consumer to re-orient or otherwise manipulate the package containing the product.

Accordingly, it would be advantageous to be able to provide a flexible packaging material, and a package formed therewith, that is capable of containing a product therewithin and that is capable of being stored and transported in such a manner as to reduce the volume of space required to contain a plurality of such packages. It would also be advantageous to be able to provide a flexible packaging material, and package formed therewith, that is capable of forming a package that can be given a desired shape and configuration and can maintain such a shape and configuration in order to enable the package to be placed on a surface, such as a shelf, for presentation to a consumer in a manner that enables the consumer to perceive the product information and any other marketing material represented on the package. It would also be advantageous to be able to provide a flexible packaging material, and a package form therewith, that is capable of providing a package that can be given a desired shape and configuration for presentation of product information and other marketing material represented on the package to a consumer in a manner intended by the manufacture such that the consumer will view and perceive the product information and other marketing and material in a controlled manner.

### SUMMARY OF THE INVENTION

Accordingly, in one aspect, the present invention provides a laminated sheet of flexible packaging material, the laminated sheet including:

a first layer formed out of unconnected sheets having substantially abutting adjacent edges,
a second layer laminated to the first layer and formed out of a continuously intact sheet where overlapping the adjacent substantially abutting edges of the sheets of the first layer;
wherein the adjacent substantially abutting edges of the sheets of the first layer define a line of weakness of the laminated sheet to encourage folding of the laminated sheet along the line of weakness.

In one form, the laminated sheet includes two opposite surfaces and includes a rib that is formed by folding the laminated sheet at least once whereby one of the first surface and the second surface includes a pair of panels facing each other.

In another form, the pair of panels facing each other are heat bonded such that the pair of panels have been partially melted and bonded with each other.

In yet another form, the laminated sheet is folded at least a second time whereby the other one of the first surface and the second surface includes a second pair of panels facing each other and at least partially overlapping the first pair of panels facing each other.

In one form, different materials are used to form the two surfaces of the laminated sheet and one of the materials has a lower melting point than the other such that when heat of a predetermined temperature is applied to the two pairs of panels one of the pairs of panels are selectively partially melted and bonded with each other.

In another form, the laminated sheet has a thickness that is the combined thickness of the laminated layers and a line of reduced thickness is formed in the laminated sheet to encourage folding of the laminated sheet along the line of reduced thickness.

In yet another form, the thickness of the laminated sheet along the line of reduced thickness is substantially less than the thickness of the laminated sheet adjacent to the line of reduced thickness.

In one form, the laminated sheet further includes a third layer laminated to the first layer, the third layer formed out of a continuously intact sheet where overlapping the adjacent substantially abutting edges of the sheets of the first layer.

In one form, the first layer is formed out of polyethylene terephthalate (PET), one of the second and third layers is formed out of polyethylene (PE) and the other one of the second and third layers is formed out of oriented polypropylene (OPP).

In another aspect, the present invention provides a package including at least one wall formed from a laminated sheet of flexible packaging material and having an interior for containing contents when the package is in an open condition, the laminated sheet including:

a first layer formed out of unconnected sheets having substantially abutting adjacent edges,
a second layer laminated to the first layer and formed out of a continuously intact sheet where overlapping the adjacent substantially abutting edges of the sheets of the first layer;
wherein the adjacent substantially abutting edges of the sheets of the first layer define a line of weakness of the laminated sheet to encourage folding of the laminated sheet along the line of weakness.

In one form, the first layer of the flexible packaging material is disposed inwardly and the second layer of the flexible packaging material is disposed outwardly relative to the interior of the package.

In another form, the laminated sheet includes two opposite surfaces and the package includes in a lay flat condition a rib that that is formed of at least two pairs of panels over laying each other wherein each pair of panels includes panels of the same surface facing each other, one of the pairs of panels are partially melted and bonded with each other and the other one of the pairs of panels are not bonded with each other.

In one form, in an open condition the package includes a base and four walls adjoining at four corners and upstanding from the base, the base and the walls are formed out of the laminated sheet of flexible packaging material.

In yet another form, the rib extends continuously through each of the walls in a direction substantially parallel to the base and spaced apart from the base whereby the rib forms a structural member for supporting the walls when the package is in the open condition.

In still yet another form, the base is rectilinear and the rib forms a rectilinear structural member for supporting the walls in a substantially box shape.

In one form, the rib extends along at least one of the corners adjoining adjacent pairs of the walls whereby the rib forms a structural member for supporting the walls when the package is in the open condition.

In yet another form, in the lay flat condition the flexible packaging material includes a gusset formed by at least one fold along at least one of the lines of weakness.

In one form, the package further includes a third layer laminated to the first layer, the third layer formed out of a continuously intact sheet where overlapping the adjacent substantially abutting edges of the sheets of the first layer.

In one form, the first layer is formed out of polyethylene terephthalate (PET), one of the second and third layers is formed out of polyethylene (PE) and the other one of the second and third layers is formed out of oriented polypropylene (OPP).

In another aspect, the present invention provides a method of forming a sheet of flexible packaging material, the sheet including a line of structural weakness to encourage folding of the laminated sheet along the line of structural weakness, the method including:
providing a first layer formed out of unconnected sheets having substantially abutting adjacent edges,
laminating a second layer to the first layer wherein the second layer is formed out of a continuously intact sheet where overlapping the adjacent substantially abutting edges of the sheets of the first layer;
whereby the adjacent substantially abutting edges of the of the sheets of the first layer define a line of structural weakness of the laminated sheet.

In one form, the step of providing the first layer includes continuously feeding a sheet and cutting the sheet to form the unconnected sheets having substantially abutting adjacent edges.

In another form, the step of laminating the second layer to the first layer includes applying adhesive to a side of at least one of the first and second layer and bringing together the first and second layers.

In one form, the method further includes providing a rib along the laminated sheet.

In one form, wherein the rib is provided by folding the laminated sheet at least once whereby one of the first surface and the second surface includes a pair of panels facing each other to form a rib in the laminated sheet.

In another form, the method further includes applying heat to the at least two panels facing each other such that the pair of panels partially melt and bond with each other.

In yet another form, the method further includes folding the laminated sheet at least a second time whereby the other one of the first surface and the second surface includes a second pair of panels facing each other and at least partially overlapping the first pair of panels facing each other.

In still yet another form, the method further includes applying heat to first and second pairs of panels facing each other such that one of the pairs of panels are selectively partially melted and bonded with each other.

In one form, the method further includes deforming the laminated sheet to form a line of reduced thickness in the laminated sheet to encourage folding of the laminated sheet along the line of reduced thickness.

In one form, the step of deforming the laminated sheet includes heating and compressing the laminated sheet with a heated die member along a line of compression.

In yet another form, the method further includes laminating a third layer to the first layer, the third layer formed out of a continuously intact sheet where overlapping the adjacent substantially abutting edges of the sheets of the first layer.

In one form, the first layer is formed out of polyethylene terephthalate (PET), one of the second and third layers is formed out of polyethylene (PE) and the other one of the second and third layers is formed out of oriented polypropylene (OPP).

In another aspect, the present invention provides a method of forming a package, the package including at least one wall formed from a laminated sheet of flexible packaging material and having an interior for containing contents when the package is in an open condition, the method including:
continuously feeding a laminated sheet of flexible packaging material including a first layer formed out of unconnected sheets having substantially abutting adjacent edges, a second layer laminated to one side of the first layer and a third layer laminated to the other side of the first layer, the second and third layers formed out of a continuously intact sheet where overlapping the adjacent substantially abutting edges of the sheets of the first layer, wherein the adjacent substantially abutting edges of the sheets of the first layer define a line of weakness of the laminated sheet to encourage folding of the laminated sheet along the line of weakness;
continuously providing a rib for the laminated sheet in the feed direction;

folding the laminated sheet along a fold line aligned with the feed direction to form a pair of overlapping walls;
sealing the pair of overlapping walls together along consecutive and spaced apart seal lines arranged transversely to the feed direction to form adjacent packages having a closed edge, at least one sealed edge and an opening; and
separating the adjacent packages by transversely cutting the overlapping walls.

In one form, the pair of overlapping walls are sealed together along consecutive and spaced apart seal lines arranged transversely to the feed direction to form adjacent packages having a closed edge, a pair of parallel and spaced apart sealed edges and an opening opposite the closed edge.

In another form, the step of separating the adjacent packages involves transversely cutting the overlapping walls substantially through the centre of the seal line.

In another form, the pair of overlapping walls are sealed together along a seal line in the feed direction and along a seal line transverse to the feed direction to form adjacent packages having a closed edge and three sealed edges, wherein the closed edge and one of the sealed edges define a pair of opposite parallel edges and the other sealed edges define a pair of opposite parallel sealed edges.

In yet another form, the step of separating the adjacent packages involves transversely cutting the overlapping walls adjacent to one of the sealed edges to form an opening for the package.

In one form, the step of continuously providing a rib for the laminated sheet in the feed direction includes folding the laminated sheet to form a pair of panels over laying and facing each other and applying heat to partially melt and bond the pair of panels to each other.

In another form, the step of continuously providing a rib for the laminated sheet in the feed direction includes bonding a strip of material to the laminated sheet in the feed direction.

In one form, the method further includes forming a gusset at the closed edge of the laminated sheet along the fold line prior to sealing the pair of overlapping walls together, wherein in a open condition of the package the gusset forms a base of the package.

In another form, the method further includes deforming the laminated sheet to form a line of reduced thickness in the laminated sheet prior to the step of folding the laminated sheet to form the pair of overlapping walls, the line of reduced thickness for encouraging folding of the laminated sheet along the line of reduced thickness

In one form, the step of deforming the laminated sheet includes heating and compressing the laminated sheet with a heated die member along a line of compression.

In another form, the method includes selectively removing a portion of at least one of the second and third layers of the laminated sheet to uncover a surface of the first layer.

In yet another form, the method includes forming a pair of opposite and parallel gussets extending in a direction substantially parallel to the opposite closed edge and sealed edge to form an opposite pair of the walls when the package is in an open condition.

In another aspect, the present invention provides an apparatus for forming a sheet of flexible packaging material, the apparatus including, the apparatus including:
a supply of a first layer of a material formed out of unconnected sheets having substantially abutting adjacent edges,
a supply of a second layer of a material in the form of a continuously intact sheet;
a pair of nip rollers for receiving the first and second layers therebetween in a feed direction to laminate the first and second layers together;
wherein the second layer is continuously intact where overlapping the adjacent substantially abutting edges of the sheets of the first layer, whereby the adjacent substantially abutting edges of the of the sheets of the first layer define a line of structural weakness of the laminated sheet to encourage folding of the laminated sheet along the line of structural weakness.

In one form, the apparatus further includes a cutting device for cutting a single sheet of the material forming the first layer step to form the unconnected sheets having substantially abutting adjacent edges.

In another form, the apparatus further includes an adhesive applicator for applying adhesive to a side of at least one of the first and second layer before laminating the first and second layers between the nip rollers.

In yet another form, the apparatus further includes a folding device for folding the laminated sheet at least once along a fold line in the feed direction whereby one of the first surface and the second surface includes a pair of panels facing each other to provide a rib along the laminated sheet.

In one form, the folding device includes at least one rounded edge for engaging the laminated sheet and continuously tucking-in a portion of the laminated sheet to form the fold line in the feed direction.

In one form, the apparatus further includes a heated element for compressing and heating the pair of panels facing each other such that the panels partially melt and bond with each other.

In another form, the apparatus further includes a die press including at least one elongated ridge for contacting and deforming the laminated sheet along a line of compression to form a line of reduced thickness in the laminated sheet to encourage folding of the laminated sheet along the line of reduced thickness.

In one form, the die press is heated.

In one form, the apparatus further includes a supply of a third layer of a material of a material in the form of a continuously intact sheet wherein the pair of nip rollers receives the first, second and third layers layers the feed direction to laminate the first, second and third layers together.

In another aspect, the present invention further provides an apparatus for forming a package from a sheet of flexible packaging material, the apparatus including:
a supply of a sheet of flexible packaging material including opposite first and second surfaces for continuously feeding the sheet of flexible packaging material in a feed direction;
a first folding device for folding the laminated sheet at least once along a fold line in the feed direction whereby one of the first surface and the second surface includes a pair of panels facing each other to provide a rib along the laminated sheet;
a second folding device for continuously folding the laminated sheet along a fold line in the feed direction to form a pair of overlapping walls;
a sealing device for sealing the pair of overlapping walls together along consecutive and spaced apart seal lines arranged transversely to the feed direction to form adjacent packages having a closed edge along the fold line formed by the second folding device, at least one sealed edge and an opening; and
a cutting device for separating the adjacent packages by transversely cutting the overlapping walls.

In one form, the apparatus further includes a die press including at least one elongated ridge for contacting and deforming the laminated sheet along a line of compression to form a line of reduced thickness in the laminated sheet to encourage folding of the laminated sheet along the line of reduced thickness.

In one form, the supply of the sheet of flexible packaging material includes:
a supply of a first layer of a material formed out of unconnected sheets having substantially abutting adjacent edges,
a supply of a second layer of a material in the form of a continuously intact sheet;
a pair of nip rollers for receiving the first and second layers therebetween in a feed direction to laminate the first and second layers together;
wherein the second layer is continuously intact where overlapping the adjacent substantially abutting edges of the sheets of the first layer, whereby the adjacent substantially abutting edges of the of the sheets of the first layer define a line of structural weakness of the laminated sheet to encourage folding of the laminated sheet along the line of structural weakness.

In one form, the apparatus further includes a punching device for selectively punching and removing a portion of at least one of the second and third layers of the laminated sheet to uncover a surface of the first layer.

In one form, the cutting device for separating the adjacent packages involves transversely oriented blade operable for cutting the overlapping walls substantially through the centre of the seal line.

In one form, the first folding device includes an apparatus for providing at least four folds in the laminated sheet along at least four fold lines in the feed direction whereby each one of the four fold lines are parallel and spaced apart from each other to provide at least four of the ribs along the laminated sheet.

In one form, the apparatus further includes a heated element for compressing and heating the pair of panels facing each other such that the panels partially melt and bond with each other.

In another form, the apparatus further includes a gusseting station for forming a gusset along the fold line at the closed edge of the laminated sheet prior to sealing the pair of overlapping walls together, wherein in an open condition of the package the gusset forms a base of the package.

In yet another form, the apparatus further includes a gusseting station for forming a pair of opposite and parallel gussets extending in a direction substantially parallel to the opposite closed edge and sealed edge to form an opposite pair of the walls when the package is in an open condition.

The lines of weakness of the laminated sheet are advantageous in that in the process of producing a package the flexible packaging material is encouraged to fold, and will tend to fold more easily in a predetermined fashion along the lines of weakness. Furthermore, the lines of weakness in the laminated sheet of flexible package material may be advantageous in encouraging folding of the laminated sheet in a package after production of the package in a desired manner such as in the process of expanding the package from the lay-flat condition to the open condition for subsequent filling of the package with contents. The lines of weakness may also be advantageous in encouraging the flexible packaging material of a package to provide or include gussets that are readily openable or expandable to provide the package with its desired shape in the open condition. The lines of weakness of the flexible packaging material may also be advantageous in providing folds, corners and the like between one or more of the base and side walls of the package that are less inclined to straighten as a result of the mechanical properties of the flexible packaging material causing the flexible packaging material to assume a substantially planar configuration or a configuration of the flexible packaging material prior to folding and or the provision of corners and the like. Accordingly, the resulting package will more readily maintain its shape in the open condition, such as the substantially box shape adopted by the base and the walls of the package.

The inclusion of one or more ribs in the laminated sheet of flexible packaging material is advantageous in that when a package is formed from the flexible packaging material and when the package is in the open condition the ribs provide structural support for the walls of the package. For example, in embodiments described herein the ribs act as structural support members to support the walls of the package in a substantially box-like configuration. By supporting the package in a substantially box-like configuration the package can rest horizontally on a surface on its base in an upright position and can more readily resist overturning. Furthermore, by maintaining the package in a substantially box-like configuration in the open condition when containing contents and stacked along with a plurality of like packages in a volume the proportion of the volume that is inefficiently utilized is reduced. Furthermore, the walls of the package are presented in a desired, preferably upright manner, such that any product information, marketing material or any other information presented on the walls of the package, such as by printing on the walls of the package, are presented in a manner that can be readily viewed and ascertained by a consumer without requiring the consumer to manipulate the package.

### BRIEF DESCRIPTION OF THE DRAWINGS

It would be convenient to hereinafter describe the invention in detail with reference to the attached drawings that schematically illustrate preferred embodiments of a flexible packaging material, a package, a method and an apparatus for forming the flexible packaging material and the package in accordance with the invention. It should be appreciated, however, that the generality of the preceding portion of the specification is not to be superseded by the specifics of the following description.

FIG. 1 illustrates a perspective view of a package formed out of a laminated sheet of flexible packaging material in accordance with an embodiment of the invention including a rib extending continuously through each wall of the package in a direction substantially parallel to the base of the package.

FIG. 2 illustrates a perspective view of a package in accordance with another embodiment of the invention including a rib extending along corners adjoining adjacent pairs of walls of the package.

FIG. 3 illustrates a schematic view of an apparatus for forming a laminated sheet of flexible packaging material in accordance with an embodiment of the invention.

FIG. 4 illustrates a perspective view of the apparatus of FIG. 3 for forming a laminated sheet of flexible packaging material in accordance with an embodiment of the invention.

FIG. 5 illustrates a portion of flexible packaging material in accordance with an embodiment of the invention illustrating folds formed in the laminated sheet to form the rib in accordance with an embodiment of the invention.

FIG. 6 illustrates a side view of a cross section of a die used to deform the laminated sheet of flexible packaging material to form a line of reduced thickness in the laminated sheet to encourage folding of the laminated sheet along the line of reduced thickness in accordance with an embodiment of the invention.

FIG. 7 illustrates a plan view of a portion of laminated flexible packaging material including a plurality of parallel ribs arranged along a feed direction of the laminated sheet used to form the package illustrated in FIG. 2 in accordance with an embodiment of the invention.

FIG. 8 illustrates a perspective view of an apparatus for providing folds in a portion of laminated sheet of flexible packaging material being fed continuously wherein the folds are provided to form ribs in the laminated sheet in accordance with an embodiment of the invention.

FIG. 9 illustrates a portion of a laminated sheet of flexible packaging material in accordance with an embodiment of the invention including a pair of parallel spaced apart ribs and parallel and spaced apart adjacent and substantially abutting edges of sheets of the first layer of the lamenting sheet defining lines of weaknesses of the laminating sheet aligned with the feed direction of the laminated sheet as well lines of reduced thickness formed in the laminated sheet.

FIG. 10 illustrates the portion of the laminated sheet of flexible packaging material of FIG. 9 wherein the laminated sheet has been folded substantially in half along the feed direction of the laminated sheet to form a pair of overlapping walls and wherein the pair of overlapping walls have been sealed together along consecutive and spaced apart seal lines arranged transversely to the feed direction to form adjacent packages having a closed edge, a pair of parallel and spaced apart sealed edges and an opening opposite the closed edge.

### DETAILED DESCRIPTION

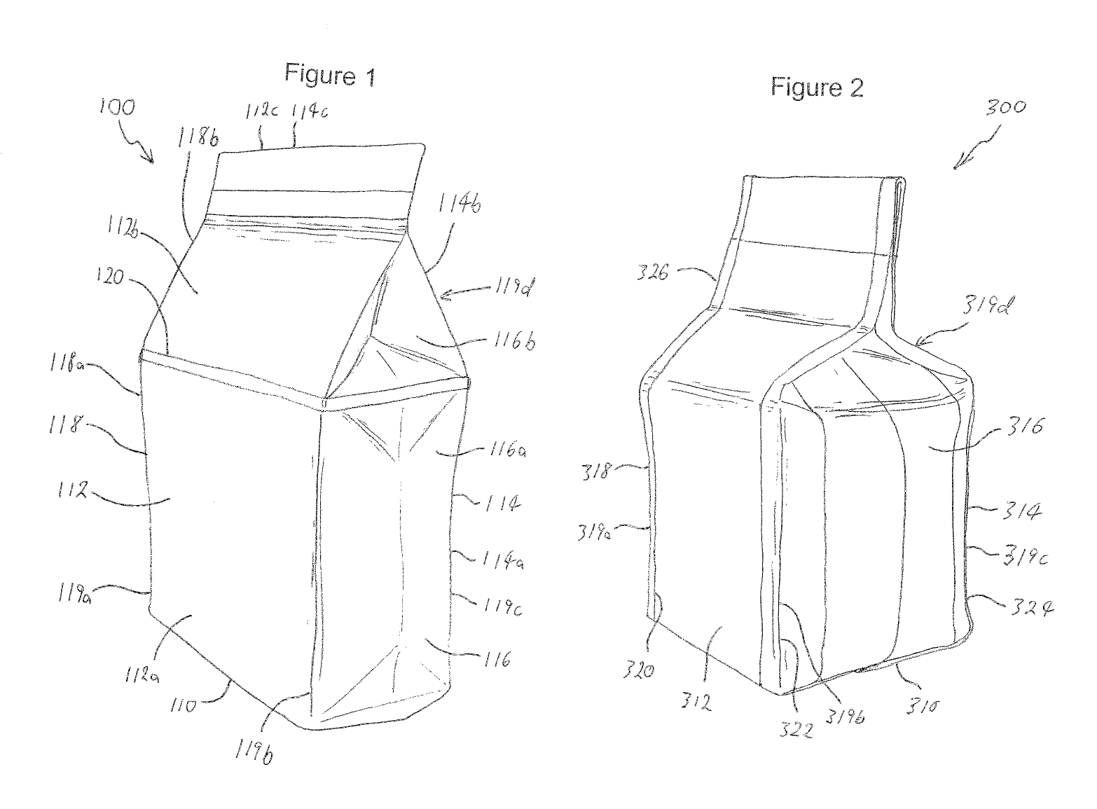

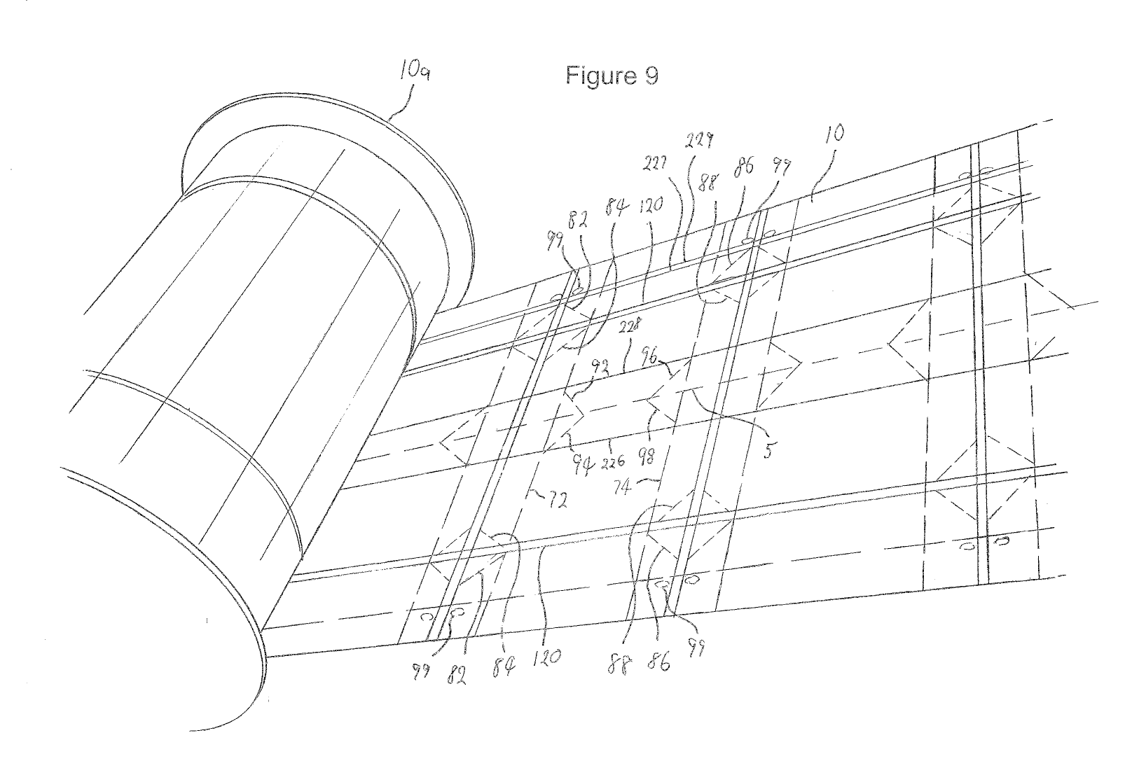

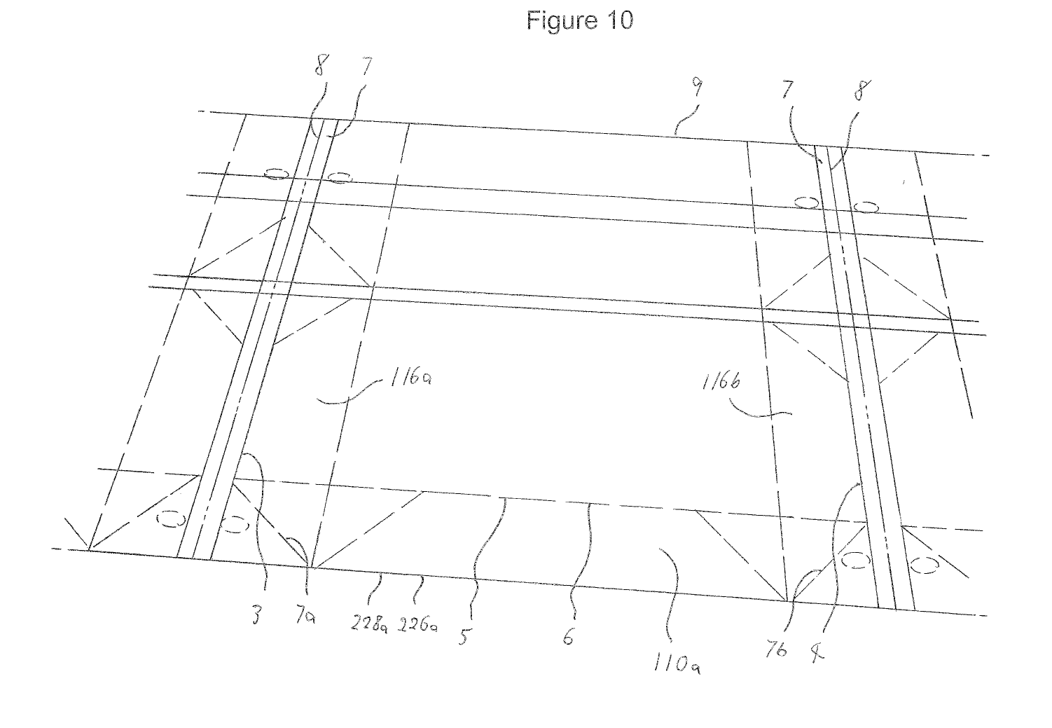

Referring to FIG. 1 there is shown a package 100 in accordance with an embodiment of the invention formed out of laminated sheets of flexible packaging material as illustrated in FIG. 9 in accordance with an embodiment of the invention. The package 100 includes a base 110, a first pair of opposite walls 112, 114 upstanding from the base 110 and a second pair of opposite walls 116, 118 also upstanding from the base 110. Each of the first pair of opposite walls 112, 114 adjoins both of the second pair of opposite walls 116, 118 to provide four corners 119A, 1196, 119C, 119D of the package 100 upstanding from four corners of the base 110. A rib 120 is integrally formed with, or is applied to, each of the walls 112, 114, 116, 118 at a distance spaced apart from the base 110 such that the rib 120 runs substantially parallel to the base 110. Accordingly, when the package 100 is rested upon a surface, such as is shown in FIG. 1, the rib 120 is arranged substantially horizontally and extends about a circumference of the adjoining walls 112, 114, 116, 118 of the package 100. When the package is in an open condition as illustrated in FIG. 1 the rib 120 provides reinforcement for the walls 112, 114, 116, 118 so as to maintain the walls 112, 114, 116, 118 in a substantially box-like configuration. Each one of the first pair of opposite walls 112, 114 thereby includes a substantially upright surface portion, 112A, 114A extending between the base 110 and the rib 120 and a sloping portion 112B, 114B extending from the rib 120 and terminating at respective edges 112C, 114C located distally from the base 110. Each of the second pair of opposite side walls 116, 118 also includes a substantially upright surface 116A, 118A extending between the base 110 and the rib 120 that in the lay-flat condition of the package 110, as illustrated in FIG. 10, includes a number of fold lines as will be described in more detail below. Furthermore, each of the second pair of opposite side walls 116, 118 includes a gusseted portion 116B, 118B extending from the rib 120 and terminating in the region of the terminating edges 112C, 114C of the first pair of opposite side walls 112, 114.

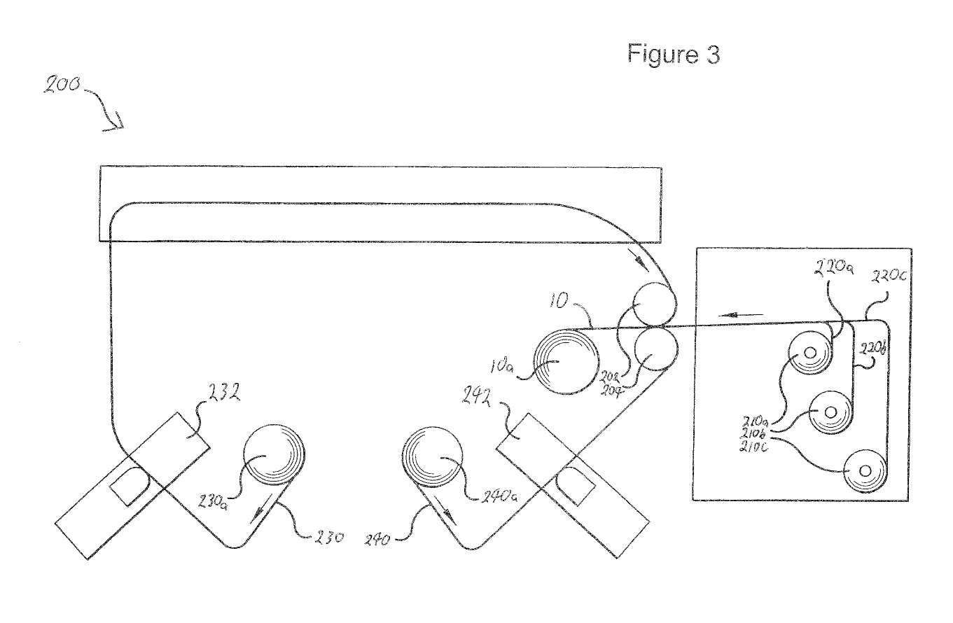

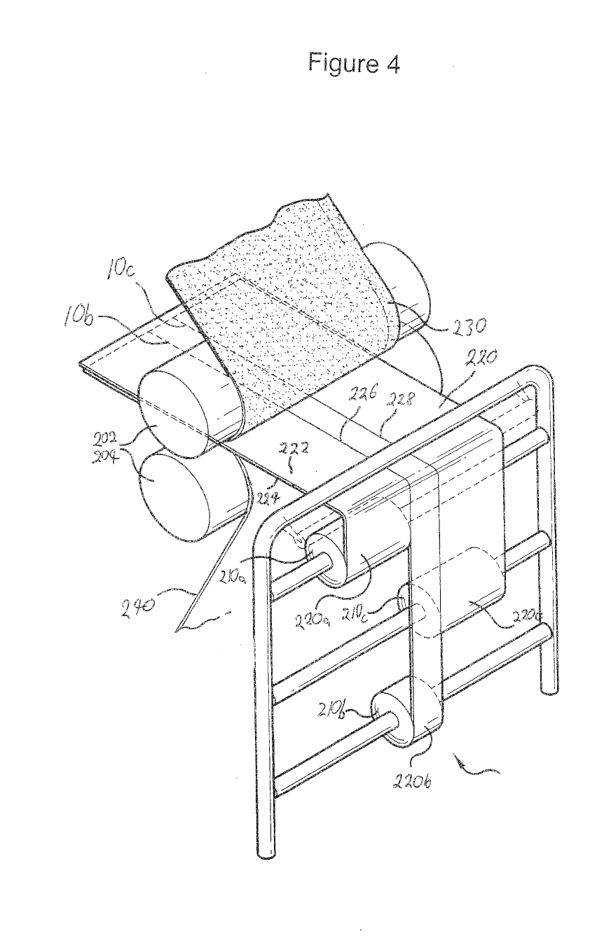

Referring to FIGS. 3 and 4, there is shown an apparatus 200 for producing laminated flexible packaging material 10 for use in producing packages such as the package 100 illustrated in FIG. 1. The apparatus 200 includes first, second and third fed rolls 210A, 210B, 210C for feeding first, second and third unconnected sheets 220A, 220B, 220C. The first layer 220 made of the first, second and third sheets 220A, 220B, 220C are fed from the rollers 210A, 210B, 210C between a pair of nip rollers 202, 204. Simultaneously, a second sheet of flexible material 230 is fed from a roll 230A and an adhesive is applied thereto by an adhesive applicator 232. After the application of adhesive the second layer 230 is fed between the nip rollers 202, 204 where the second sheet 230 is brought into face to face contact with a first surface 222 of the first layer 220 including the unconnected first, second and third sheets 220A, 220B, 220C to be compressed and adhered thereto. In a preferred form, a third sheet 240 is fed from a roll 240 to another adhesive applicator 242 which applies adhesive to a surface of a third sheet 240. After the application of adhesive the third layer 240 is fed between the nip rollers 202, 204 to be adhered to a second surface 224 of the first layer 220. Thus, after the first, second and third layers 220, 230, 240 are feed between the nip rollers 202, 204 and are compressed there-between the laminated sheet of flexible packaging material 10 is formed continuously onto a roll 10A. The first layer 220 may be formed out of polyethylene terephthalate (PET) and the second layer 230 and the third layer 240 may be formed out of either polyethylene (PE) or oriented polypropylene (OPP) or both.

As can be appreciated, and as best shown in FIG. 4, the first, second and third sheets 220A, 220B, 220C of the first layer 220 abut with each other along a first pair of adjacent abutting edges 226 and a second pair of adjacent abutting edges 228. The first pair of adjacent abutting edges 226 comprises the adjacent abutting edges of the first and second sheets 220A, 220B and the second pair of adjacent abutting edges comprise the adjacent abutting edges of the second and third sheets 220B, 220C. It is to be appreciated that the adjacent abutting edges may be in abutment, substantially in abutment or slightly separated from each other by a small distance such that when the first, second and third sheets 220A, 220B, 220C of the first layer 220 are laminated to at least the second layer 230, which is formed out of a continuously intact sheet where it overlaps with the first and second pair of adjacent abutting adjacent edges 226, 228, and, optionally, with the third layer 240 which can also be formed out of continuously intact sheet where overlapping the adjacent substantially abutting edges 226, 228 of the first layer 220, the resulting laminating sheet of flexible packaging material 10 is provided with lines of weakness defined along the first and second pairs of adjacent abutting edges 226, 228. The lines of weakness illustrated in FIG. 4 represented by the numerals 10B, 100 corresponds respectively with the first and second pair of adjacent abutting edges 226, 228. The lines of weakness 10B, 100 of the laminated sheet 10 are advantageous and that in the process of producing a package, such as the package 100 illustrated in FIG. 1, the flexible packaging material 10 is encouraged to fold, and will tend to fold more easily in a predetermined fashion along the lines of weakness 10B, 100. Furthermore, the lines of weakness 10B, 100 in the laminated sheet of flexible package material 10 may be advantageous in encouraging folding of the laminated sheet 10 in a package, such as the package 100 illustrated in FIG. 1, after production of the package 100 in a desired manner such as in the process of expanding the package 100 from the lay-flat condition to the open condition for subsequent filling of the package 100 with contents. The lines of weakness 10B, 10C may also be advantageous in encouraging the flexible packaging material 10 of a package, such as the package 100 illustrated in FIG. 1, to provide or include gussets that are readily openable or expandable to provide the package 100 with its desired shape in the open condition. The lines of weakness 10B, 100 of the flexible packaging material 10 may also be advantageous in providing folds, corners and the like between one or more of the base 110 and side walls 112, 114, 116, 118 of the package 100 that are less inclined to straighten as a result of the mechanical properties of the flexible packaging material 10 causing the flexible packaging material 10 to assume a substantially planar configuration or a configuration of the flexible packaging material 10 prior to folding and or the provision of corners and the like. Accordingly, the resulting package 100 will more readily maintain its shape in the open condition, such as the substantially box shape adopted by the base 100 and the walls 112, 114, 116, 118 of the package 100 illustrated in FIG. 1.

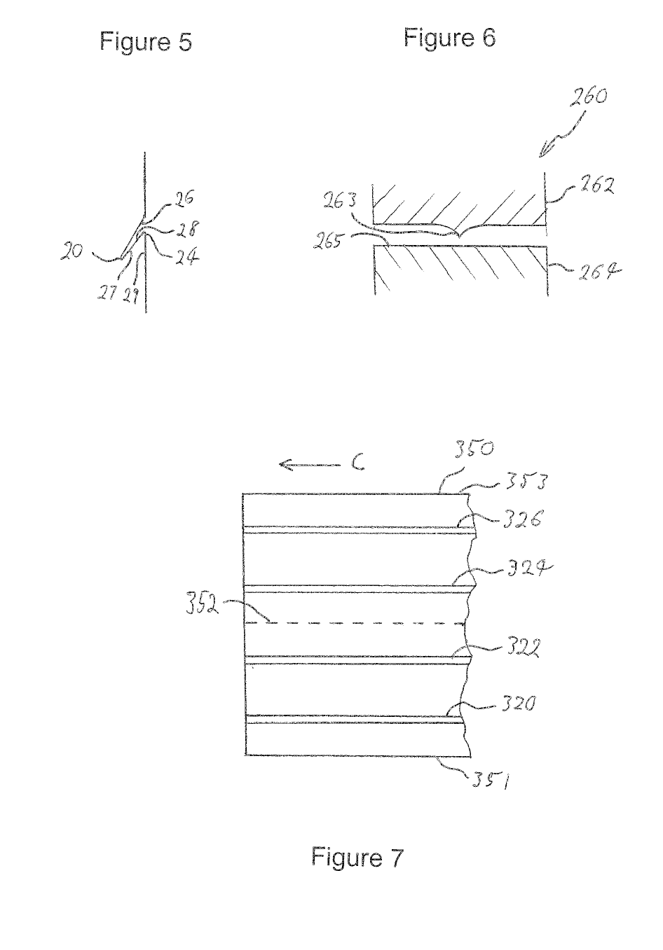

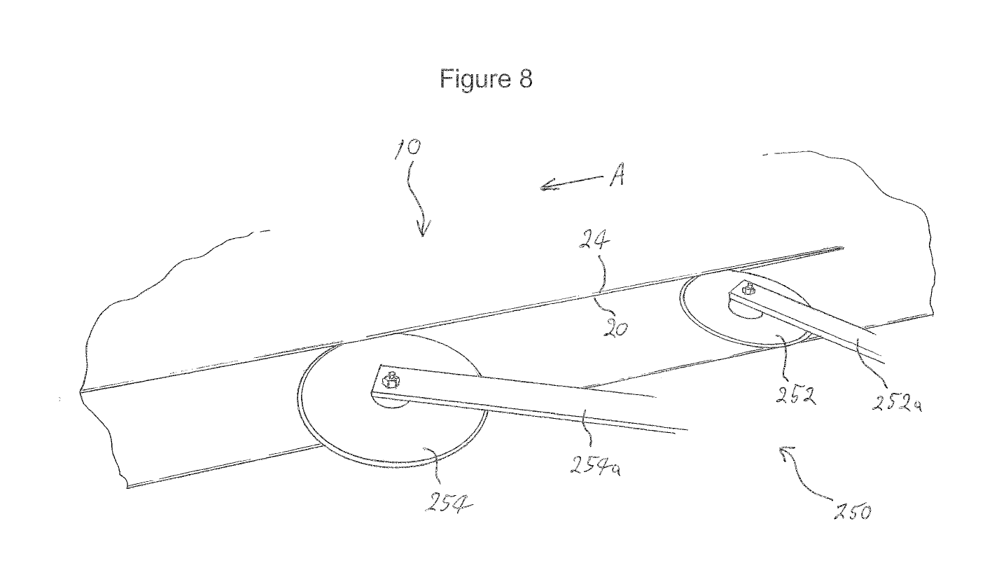

Referring to FIG. 8, there is shown a device 250, including a first wheel 252 and a second wheel 254 each respectively rotatably mounted to first and second mounting arms 252A, 254A. In an apparatus for forming the package, such as the package 100 illustrated in FIG. 1, the sheet of flexible packaging material 10 is fed from the roll 10A continuously in a direction represented by arrow A in FIG. 8 to the first wheel 252 and subsequently the second wheel 254 wherein the first and second wheels 252, 254 are arranged in substantially the same plane as the laminated sheet 10. The first and second wheels 252, 254 are operable to tuck-in a portion of the flexile packaging material 10 so as to provide the packaging material 10 with at least one, but preferably first and second folds 20, 24, as best shown in FIG. 5. As a result of the at least one fold 20 and preferably two folds 20, 24, at least one of the first layer 220, the second layer 230 and the third layer 240 include a pair of panels 26, 28 facing each other. In an embodiment in which the first layer 220 is laminated between the second and third layers 230, 240 the pair of panels 26, 28 facing each other will involve portions of either the second layer 230 or the third layer 240 directly facing each other and in contact with each other. Furthermore, the first and second folds 20, 24 result in a second pair of panels 27, 29 also facing each other. The second pair of panels 27, 29, in this embodiment, will be comprise the other one of the second and third layers 230, 240 being arranged face to face and in contact with each other. After applying the first and second folds 20, 24 to the flexible material 10 as illustrated in FIG. 8 the flexible material 10 subsequently moves to a device (not shown) for applying heat and pressure to the flexible packaging material 10 at least in the region of the first and second folds 20, 24. As can be seen in FIG. 5, the first pair of panels 26, 28 overlap with the second pair of panels 27, 29. In a preferred embodiment, the material forming the second layer 230 will be different to the material forming the third layer 240, and in particular the material forming the second layer 230 will have a different melting point to the material forming the third layer 240, such that the with application of heat and pressure at a desired or predetermined temperature only the material forming one of the second and third layers 230, 240 will reach its melting point. This will result in at least partial melting of the material forming either the first pair of overlapping panels 26,28 or the second pair of overlapping panels 27, 29 to result in selective heat welding or bonding of either the first pair of panels 26, 27 in face to face relation to each other or the second pair of panels 27, 29 in face to face relationship with each other. As a result, the flexible packaging material 10 will be provided with the rib 120 which can be seen in the embodiment of the packaging 100 illustrated in FIG. 1 and in an embodiment of the flexible packaging material 10 illustrated in FIG. 9.

Referring to FIG. 9, there is shown a length of the flexible packaging material 10 extending from a roll 10A thereof. The flexible packaging material 10 includes a pair of the ribs 120 spaced apart and parallel to each other. Furthermore, a plurality of lines of weakness 226, 228 are provided that are arranged parallel and spaced apart from each other. Further lines of weakness 227, 229 are provided that are formed in the same manner as the lines of weakness 226, 228 as described above. The laminated sheet 10 further includes a series of lines of reduced thickness 72, 74, 82, 84, 86, 88, 92, 94, 96, 98. The purpose of the lines of reduced thickness will be described below. However, the means by which the lines of reduced thickness will now be described.

Referring to FIG. 6, there is shown a heated die apparatus 260. The die apparatus 260 includes first and second die members 262, 264. The first die member includes an elongated projection or ridge 263 that can be linear or non linear whereas the second die member 264 includes a substantially planar surface 265. The first and second die members 262, 264 are arranged in a press machine and at least one of the first and second die members 262, 264 is heated. The flexible packaging material 10 is fed between the first and second die members 262, 264 and that the machine press presses the first and second die members 262, 264 towards each other to thereby deform the laminated sheet of flexible packaging material 10 positioned therebetween. As a result, the elongated projection 263 deforms the flexible packaging material 10 along lines of deformation to thereby form the lines of reduced thickness 72, 74, 82, 84, 86, 88, 92, 94, 96, 98 in the flexible packaging material 10 as illustrated in FIG. 9. By heating at least one of the first and second die members 262, 264 the material forming the laminated sheet of flexible packaging material 10 is deformed and at least partially melted so as to retain the lines of reduced thickness formed in the laminated sheet. The lines of reduced thickness 72, 74, 82, 84, 86, 88, 92, 94, 96, 98 are provided in the laminated sheet of flexible packaging material 10 to encourage folding of the laminated sheet 10 along the lines of reduced thickness in a package formed from the laminated sheet 10 such as the packaging 100 illustrated in FIG. 1.

Furthermore, as can be seen in the laminated sheet of flexible packaging material 10 illustrated in FIG. 9, the flexible packaging material 10 has had portions of one or more of the first, second and third layers 220, 230, 240 removed to thereby leave exposed portions 99 of a surface, such as the first or second surfaces 222, 224 of the first layer 220. A punching device can be used for this purpose. By exposing the exposed portions 99 of the one or more of the first, second and third layers 220, 230, 240 during a subsequent processing step the exposed portion 99 may be selectively heat weldable or bondable to another surface, such as another exposed portion 99, whilst a surface surrounding the exposed portion 99, such as a surface of the second or third layers 230, 240 may not heat bond at the same temperature at which the exposed portions 99 will heat bond.

In order to form a package from the sheet of flexible packaging material 10, such as the package 100 illustrated in FIG. 1, the sheet of flexible packaging material 10, as illustrated in FIG. 9, is fed from the roll 10A and in a fed direction represented by the arrow B and is subsequently folded along a fold lines aligned with the feed direction B that is preferably substantially in the centre of the laminated sheet 10. As a result of folding the laminated sheet 10 is substantially bisected in the feed direction B to form a pair of overlapping walls as illustrated in FIG. 10. As illustrated in FIGS. 9 and 10 the fold line 5 about which the flexible packaging material 10 is bisected is illustrated.

The bisected flexible packaging material 10 illustrated in FIG. 10 is then provided a gusset 110a extending along the closed edge 6 by folding the flexible packaging material 10 inwards along the lines of weakness formed by the pairs of adjacent abutting edges 226, 228 illustrated in FIG. 9. The gusset 110a formed in this process will ultimately form the base 110 of the package 100 illustrated in FIG. 1. As a result of the gusseting step folds 226a, 228a are formed along the lines of weakness formed by the pairs of adjacent abutting edges 226, 228. These folds 226a, 228a can be additionally strengthened by an additional heat sealing step whereby the material forming the interior surface of the bisected and gusseted sheet of flexible packaging material 10 is heated and compressed to thereby be heat bonded to each other along a border region along the folds 226a, 228a.

The bisected and gusseted flexible packaging material 10 illustrated in FIG. 10 is then provided with a succession of transverse of lateral seals 7 and at least two corner seals 7b, 7c that are arranged at an angel or slope relative to the transverse lateral seals 7. Each successive transverse seal 7 is spaced apart by a distance equivalent to the width of each package, such as the package 100 illustrated in FIG. 1. The transverse seals 7 may be provided by any suitable method, such as through the application of heat and pressure to weld the overlapping walls of the packaging material 10 together. After completion of the transverse seals 7 the sheet of flexible packaging material 10 is cut along a cut line 8 that is located substantially centrally within the region of the transverse seal 7. The cut 8 extends transversely to the feed direction B between and two opposite lateral edges of the overlapping walls of the flexible packaging material 10. A package, such as the package illustrated in FIG. 10, is separated from adjacent packages by each successive cut 8. The resulting in package, such as the package 100 illustrated in FIG. 1, includes, in the lay-flat condition, a closed edge 6 along the fold line 5, a pair of opposite, spaced apart and parallel sealed edges 3, 4 upstanding from the closed edge 6 and extending to an open edge 9. The open edge 9 is opposite, spaced apart and substantially parallel to the closed edge 6. As can be appreciated, the package resulting from the sheet of flexible package material illustrated in FIG. 10 substantially corresponds to the shape and configuration of the package 100 illustrated in FIG. 1 when in the open condition. In the open configuration of the package 100 the corner seals 7b, 7c are operable for ensuring that the gusset 110a opens into a substantially flat base 110 upon which the package 100 can rest in a stable manner.

Referring to FIG. 2 there is shown a package 300 in accordance with another embodiment of the invention. Instead of the horizontal rib 120 of the package 100 in the open condition of FIG. 1, the package 300 in the open condition illustrated in FIG. 2 includes a plurality of vertical ribs 320, 322, 324, 326. The flexible packaging material 350 from which the package 300 is formed is illustrated in FIG. 7. The sheet of flexible package material 350 illustrated in FIG. 7 includes the four ribs 320, 322, 324, 326 arranged substantially parallel and spaced apart from each other and aligned with the feed direction represented by the arrow C. Each one of the ribs 320, 322, 324, 326 of the sheet of flexible packaging material 350 illustrated in FIG. 7 is formed in substantially the same manner as the rib 120 formed in the sheet of flexible packaging material 10 illustrated in FIG. 9 (i.e as illustrated in FIG. 8).

The package 300 is formed by folding the sheet of flexible packaging material 350 along the fold line 352 to bisect the sheet 350 and bring lateral edges 351, 353 of the sheet 350 together. The lateral edges 352, 353 are bonded together to form a tube. A length of the sheet of flexible packaging material 350 formed into the tube is sealed transversely and cut along a cut line adjacent to and parallel to the transverse seal to form the package 300 including a sealed base 310, a first pair of opposite side walls 312, 314 upstanding from the base 310 and a second pair of opposite walls 316, 318 upstanding from the base 310. Each of the first pair of opposite side walls 312, 314 adjoins each of the second pair of opposite side walls 316, 318 along four corners 319A, 319B, 319C, 319D each upstanding from corners of the base 310. Each one of the ribs 320, 322, 324, 326 is provided along a respective one of the corners 319A, 319B, 319C, 319D. The ribs 320, 322, 324, 326 are advantageous in that when the package 300 is in the open condition, as illustrated in FIG. 2, the ribs 320, 322, 324, 326, provide structural support for the first and second pairs of opposite walls 312, 314, 316, 318 in a substantially box-like configuration as illustrated in FIG. 2. By supporting the package 300 in a substantially box-like configuration the package 300 can rest horizontally on a surface on the base 310 in an upright position and can more readily resist overturning. Furthermore, by maintaining the package 300 in a substantially box-like configuration in the open condition when containing contents and stacked along with a plurality of such packages 300 in a volume the proportion of the volume that is inefficiently utilized is reduced.

Various alterations, modifications and/or additions may be introduced into the constructions and arrangements of parts previously described without departing from the spirit and/or ambit of the invention.

1. A laminated sheet of flexible packaging material, the laminated sheet including:
a first layer formed out of unconnected sheets having substantially abutting adjacent edges, a second layer laminated to the first layer and formed out of a continuously intact sheet where overlapping the adjacent substantially abutting edges of the sheets of the first layer;
wherein the adjacent substantially abutting edges of the sheets of the first layer define a line of weakness of the laminated sheet to encourage folding of the laminated sheet along the line of weakness.

2. The laminated sheet of claim 1, wherein the laminated sheet includes two opposite surfaces and includes a rib that is formed by folding the laminated sheet at least once whereby one of the first surface and the second surface includes a pair of panels facing each other.

3. The laminated sheet of claim 2, wherein the pair of panels facing each other are heat bonded such that the pair of panels have been partially melted and bonded with each other.

4. The laminated sheet of claim 2, wherein the laminated sheet is folded at least a second time whereby the other one of the first surface and the second surface includes a second pair of panels facing each other and at least partially overlapping the first pair of panels facing each other.

5. The laminated sheet of claim 4, wherein different materials are used to form the two surfaces of the laminated sheet and one of the materials has a lower melting point than the other such that when heat of a predetermined temperature is applied to the two pairs of panels one of the pairs of panels are selectively partially melted and bonded with each other.

6. The laminated sheet of claim 1, wherein the laminated sheet has a thickness that is the combined thickness of the laminated layers and a line of reduced thickness is formed in the laminated sheet to encourage folding of the laminated sheet along the line of reduced thickness.

7-9. (canceled)

10. A package including at least one wall formed from a laminated sheet of flexible packaging material and having an interior for containing contents when the package is in an open condition, the laminated sheet including:
a first layer formed out of unconnected sheets having substantially abutting adjacent edges, a second layer laminated to the first layer and formed out of a continuously intact sheet where overlapping the adjacent substantially abutting edges of the sheets of the first layer;
wherein the adjacent substantially abutting edges of the sheets of the first layer define a line of weakness of the laminated sheet to encourage folding of the laminated sheet along the line of weakness.

11. (canceled)

12. The package of claim 10, wherein the laminated sheet includes two opposite surfaces and the package includes in a lay flat condition a rib that that is formed of at least two pairs of panels over laying each other wherein each pair of panels includes panels of the same surface facing each other, one of the pairs of panels are partially melted and bonded with each other and the other one of the pairs of panels are not bonded with each other.

13. The package of claim 12, wherein in an open condition the package includes a base and four walls adjoining at four corners and upstanding from the base, the base and the walls are formed out of the laminated sheet of flexible packaging material.

14. The package of claim 13, wherein the rib extends continuously through each of the walls in a direction substantially parallel to the base and spaced apart from the base whereby the rib forms a structural member for supporting the walls when the package is in the open condition.

15. (canceled)

16. The package of claim 13, wherein the rib extends along at least one of the corners adjoining adjacent pairs of the walls whereby the rib forms a structural member for supporting the walls when the package is in the open condition.

17-19. (canceled)

20. A method of forming a sheet of flexible packaging material, the sheet including a line of structural weakness to encourage folding of the laminated sheet along the line of structural weakness, the method including:
providing a first layer formed out of unconnected sheets having substantially abutting adjacent edges,
laminating a second layer to the first layer wherein the second layer is formed out of a continuously intact sheet where overlapping the adjacent substantially abutting edges of the sheets of the first layer;
whereby the adjacent substantially abutting edges of the of the sheets of the first layer define a line of structural weakness of the laminated sheet.

21-22. (canceled)

23. The method of claim 20, further including providing a rib along the laminated sheet.

24. The method of claim 23, wherein the rib is provided by folding the laminated sheet at least once whereby one of the first surface and the second surface includes a pair of panels facing each other to form a rib in the laminated sheet.

25-27. (canceled)

28. The method of claim 20, further including deforming the laminated sheet to form a line of reduced thickness in the laminated sheet to encourage folding of the laminated sheet along the line of reduced thickness.

29-31. (canceled)

32. A method of forming a package, the package including at least one wall formed from a laminated sheet of flexible packaging material and having an interior for containing contents when the package is in an open condition, the method including:
continuously feeding a laminated sheet of flexible packaging material including a first layer formed out of unconnected sheets having substantially abutting adjacent edges, a second layer laminated to one side of the first layer and a third layer laminated to the other side of the first layer, the second and third layers formed out of a continuously intact sheet where overlapping the adjacent substantially abutting edges of the sheets of the first layer, wherein the adjacent substantially abutting edges of the sheets of the first layer define a line of weakness of the laminated sheet to encourage folding of the laminated sheet along the line of weakness;
continuously providing a rib for the laminated sheet in the feed direction;
folding the laminated sheet along a fold line aligned with the feed direction to form a pair of overlapping walls;
sealing the pair of overlapping walls together along consecutive and spaced apart seal lines arranged transversely to the feed direction to form adjacent packages having a closed edge, at least one sealed edge and an opening; and
separating the adjacent packages by transversely cutting the overlapping walls.

33-36. (canceled)

37. The method of claim 32, wherein the step of continuously providing a rib for the laminated sheet in the feed direction includes folding the laminated sheet to form a pair of panels over laying and facing each other and applying heat to partially melt and bond the pair of panels to each other.

38-39. (canceled)

40. The method of claim 32, further including deforming the laminated sheet to form a line of reduced thickness in the laminated sheet prior to the step of folding the laminated sheet to form the pair of overlapping walls, the line of reduced thickness for encouraging folding of the laminated sheet along the line of reduced thickness

41-43. (canceled)

44. An apparatus for forming a sheet of flexible packaging material, the apparatus including, the apparatus including:
a supply of a first layer of a material formed out of unconnected sheets having substantially abutting adjacent edges,
a supply of a second layer of a material in the form of a continuously intact sheet;
a pair of nip rollers for receiving the first and second layers therebetween in a feed direction to laminate the first and second layers together;
wherein the second layer is continuously intact where overlapping the adjacent substantially abutting edges of the sheets of the first layer, whereby the adjacent substantially abutting edges of the of the sheets of the first layer define a line of structural weakness of the laminated sheet to encourage folding of the laminated sheet along the line of structural weakness.

45-52. (canceled)

53. An apparatus for forming a package from a sheet of flexible packaging material, the apparatus including:
a supply of a sheet of flexible packaging material including opposite first and second surfaces for continuously feeding the sheet of flexible packaging material in a feed direction;
a first folding device for folding the laminated sheet at least once along a fold line in the feed direction whereby one of the first surface and the second surface includes a pair of panels facing each other to provide a rib along the laminated sheet;
a second folding device for continuously folding the laminated sheet along a fold line in the feed direction to form a pair of overlapping walls;
a sealing device for sealing the pair of overlapping walls together along consecutive and spaced apart seal lines arranged transversely to the feed direction to form adjacent packages having a closed edge along the fold line formed by the second folding device, at least one sealed edge and an opening; and
a cutting device for separating the adjacent packages by transversely cutting the overlapping walls.

54-61. (canceled)
